(19) United States
(12) Patent Application Publication
(10) Pub. No.: US 2020/0368879 A1
(43) Pub. Date: Nov. 26, 2020

(54) PLIERS HAVING A FIVE-BAR LINKAGE

(71) Applicant: MING CHIEH WU, Taichung City (TW)

(72) Inventor: MING CHIEH WU, Taichung City (TW)

(21) Appl. No.: 16/503,511

(22) Filed: Jul. 4, 2019

(30) Foreign Application Priority Data
May 21, 2019 (TW) 108117495

(51) Int. Cl. B25B 7/12; B25B 7/06; B25B 7/18

(52) U.S. Cl. CPC B25B 7/12; B25B 7/18; B25B 7/06

(57) ABSTRACT

Pliers includes a first holder and a second holder. The first holder includes a first handle and a first jaw securely fixed to an end of the first handle. The second holder includes a second jaw, a first connecting member, a toggle lever, a second handle, and a second connecting member. The second jaw is pivotably mounted to the end of the first handle and faces the first jaw. The first connecting member is pivotably connected to the second jaw. An end of the toggle lever is pivotably connected to the first connecting member. An end of the second handle is pivotably connected to the first connecting member. An end of the second connecting member is pivotably connected to the toggle lever. Another end of the second connecting member is pivotably connected to the second handle.

### BACKGROUND OF THE INVENTION

The present invention relates to pliers and, more particularly, to pliers having a five-bar linkage.

Taiwan Patent No. 1513553 discloses a clamping device with a labor effort saving effect. The clamping device includes a first clamping member and a second clamping member. The first clamping member includes a first handle and a first jaw. The first jaw is connected to an end of the first handle. The second clamping member includes a second jaw and a second handle. The second jaw is pivotally connected to the first handle about a first axis and faces the first jaw. The second handle has one end pivotally connected to the second jaw about a second axis spaced from a distal end of the second handle by a first length. The second clamping member includes a toggle lever having one end pivotally connected to the second handle about a third axis spaced from the second axis by a second length that is smaller than 0.19 times the first length.

Aside from providing a labor saving effect, a user can operate the clamping device with single hand. However, the spacing between the first and second handles is relatively large when the clamping device is in an open state. Particularly, the larger the spacing between the first and second jaws, the larger the spacing between the first and second handles. Namely, the hand of the user could be not big enough for the single-hand operation even though it saves labor.

Thus, a need exists for novel pliers that mitigate and/or obviate the above disadvantages.

### BRIEF SUMMARY OF THE INVENTION

In a first aspect, pliers having a five-bar linkage includes a first holder and a second holder. The first holder includes a first handle, a first jaw, and an adjusting member. The first jaw is securely fixed to a first end of the first handle. The adjusting member is connected to a second end of the first handle remote from the first jaw. The second holder includes a second jaw, a first connecting member, a toggle lever, a second handle, and a second connecting member. The second jaw is pivotably mounted to the first end of the first handle and faces the first jaw. The first connecting member includes a first pivotal portion, a second pivotal portion, and a third pivotal portion. The first pivotal portion is pivotably connected to the second jaw. A first end of the toggle lever is pivotably connected to the second pivotal portion. A second end of the toggle lever abuts against the adjusting member. One of two ends of the second handle is pivotably connected to the third pivotal portion. A first end of the second connecting member is pivotably connected between the first and second ends of the toggle lever. A second end of the second connecting member is pivotably connected between the two ends of the second handle.

A line passing through the first pivotal portion and the second pivotal portion is not coincident with another line passing through the second pivotal portion and the third pivotal portion. The third pivotal portion is located on a side of the second pivotal portion opposite to the first handle. The first connecting member includes a first connecting section and a second connecting section. The first connecting section connects the first pivotal portion to the second pivotal portion. The second connecting section connects the second pivotal portion to the third pivotal portion. A recess is formed in an angle between a side of the first connecting section and a side of the second connecting section. The side of the first connecting section and the side of the second connecting section are opposite to the first handle. A stopper portion is formed on a side of the second connecting section adjacent to the recess.

The second holder is movable relative to the first holder between a holding position and a release position. When the second holder is in the holding position, the second jaw is adjacent to the first jaw, and the stopper portion disengages from the second handle. When the second holder is in the release position, the second jaw is away from the first jaw, and the stopper portion abuts against the second handle.

In an example, the first connecting member includes a first plate and the second plate. The first pivotal portion, the second pivotal portion, the third pivotal portion, the first connecting section, the second connecting section, and the recess are formed on the first plate. The second plate has a structure identical to the first plate. An end of the stopper portion is connected to the first plate. Another end of the stopper portion is connected to the second plate. The first plate and the second plate are on two opposite sides of the second jaw. The toggle lever is located between the first plate and the second plate. The second handle is located between the first plate and the second plate.

In an example, the second end of the first handle opposite to the first jaw includes a screw hole. The adjusting member is in threading connection with the screw hole. The adjusting member is rotatable relative to the first handle to move towards or away from the first jaw. The second end of the toggle lever is remote from the first connecting member and is jointly movable with the adjusting member relative to the first handle.

In an example, the second holder further includes an elastic element. An end of the elastic element is connected to the second jaw and is located between the first handle and the first connecting member. Another end of the elastic element is connected between the first and second ends of the first handle. The elastic element provides a pulling force for both the second jaw and the first handle.

In a second aspect, pliers having a five-bar linkage includes a first holder and a second holder. The first holder includes a first handle, a first jaw, and an adjusting member. The first jaw is securely fixed to a first end of the first handle. The adjusting member is connected to a second end of the first handle remote from the first jaw. The second holder includes a second jaw, a first connecting member, a toggle lever, a second handle, a second connecting member, and a stopper. The second jaw is pivotably mounted to the first end of the first handle and faces the first jaw. The first connecting member includes a first pivotal portion, a second pivotal portion, and a third pivotal portion. The first pivotal portion is pivotably connected to the second jaw. A first end of the toggle lever is pivotably connected to the second pivotal portion. A second end of the toggle lever abuts against the adjusting member. One of two ends of the second handle is pivotably connected to the third pivotal portion. A first end of the second connecting member is pivotably connected between the first and second ends of the toggle lever. A second end of the second connecting member is pivotably connected between the two ends of the second handle. The stopper is connected to the toggle lever and is located between the first connecting member and the toggle lever.

A line passing through the first pivotal portion and the second pivotal portion is not coincident with another line passing through the second pivotal portion and the third pivotal portion. The third pivotal portion is located on a side of the second pivotal portion opposite to the first handle. The first connecting member includes a first connecting section and a second connecting section. The first connecting section connects the first pivotal portion to the second pivotal portion. The second connecting section connects the second pivotal portion to the third pivotal portion. A first recess is formed in an angle between a side of the first connecting section and a side of the second connecting section. The side of the first connecting section and the side of the second connecting section are opposite to the first handle.

The second holder is movable relative to the first holder between a holding position and a release position. When the second holder is in the holding position, the second jaw is adjacent to the first jaw, and the stopper disengages from the second connecting member. When the second holder is in the release position, the second jaw is away from the first jaw, and the stopper abuts against the second connecting member.

In an example, the second connecting member includes a first abutting portion and a second abutting portion. An end of each of the first abutting portion and the second abutting portion is pivotably connected to the toggle lever. Another end of each of the first abutting portion and the second abutting portion is pivotably connected to the second handle. The first abutting portion and the second abutting portion are located on two opposite sides of the toggle lever. The stopper extends through the toggle lever and extends beyond the two opposite sides of the toggle lever. When the second holder is in the holding position, the stopper disengages from the first abutting portion and the second abutting portion. When the second holder is in the release position, the stopper abuts against the first abutting portion and the second abutting portion.

In an example, the second holder includes a third connecting member. The third connecting member includes a fourth pivotal portion, a fifth pivotal portion, and a sixth pivotal portion. The fourth pivotal portion is pivotably connected to the second jaw. The first connecting member and the third connecting member are mounted on two opposite sides of the second jaw, respectively. The first end of the toggle lever is pivotably connected to the second pivotal portion and the fifth pivotal portion. The toggle lever is located between the first connecting member and the third connecting member. The one of the two ends of the second handle is pivotably connected to the third pivotal portion and the sixth pivotal portion. The second handle is located between the first connecting member and the third connecting member.

A line passing through the fourth pivotal portion and the fifth pivotal portion is not coincident with another line passing through the fifth pivotal portion and the sixth pivotal portion. The sixth pivotal portion is located on a side of the fifth pivotal portion opposite to the first handle. The third connecting member includes a third connecting section and a fourth connecting section. The third connecting section connects the fourth pivotal portion to the fifth pivotal portion. The fourth connecting section connects the fifth pivotal portion to the sixth pivotal portion. A second recess is formed in an angle between a side of the third connecting section and a side of the fourth connecting section. The side of the third connecting section and the side of the fourth connecting section are opposite to the first handle.

In an example, the second end of the first handle remote from the first jaw includes a screw hole. The adjusting member is in threading connection with the screw hole. The adjusting member is rotatable relative to the first handle to move towards or away from the first jaw. The second end of the toggle lever is remote from the first connecting member and is jointly movable with the adjusting member relative to the first handle.

In an example, the second holder further includes an elastic element. An end of the elastic element is connected to the second jaw and is located between the first handle and the first connecting member. Another end of the elastic element is connected between the first and second ends of the first handle. The elastic element provides a pulling force for both the second jaw and the first handle.

The present invention will become clearer in light of the following detailed description of illustrative embodiments of this invention described in connection with the drawings.

### DESCRIPTION OF THE DRAWINGS

FIG. 1 is a perspective view of pliers having a five-bar linkage of a first embodiment according to the present invention.

FIG. 2 is an exploded, perspective view of the pliers of FIG. 1.

FIG. 3 is a cross sectional view of the pliers of FIG. 1, with a second holder located in a holding position.

FIG. 4 is a cross sectional view of the pliers of FIG. 1, with the second holder located in a release position.

FIG. 5 is a perspective view of pliers having a five-bar linkage of a second embodiment according to the present invention.

FIG. 6 is an exploded, perspective view of the pliers of FIG. 5.

FIG. 7 is a cross sectional view of the pliers of FIG. 5, with a second holder located in a holding position.

FIG. 8 is a cross sectional view of the pliers of FIG. 5, with the second holder located in a release position.

### DETAILED DESCRIPTION OF THE INVENTION

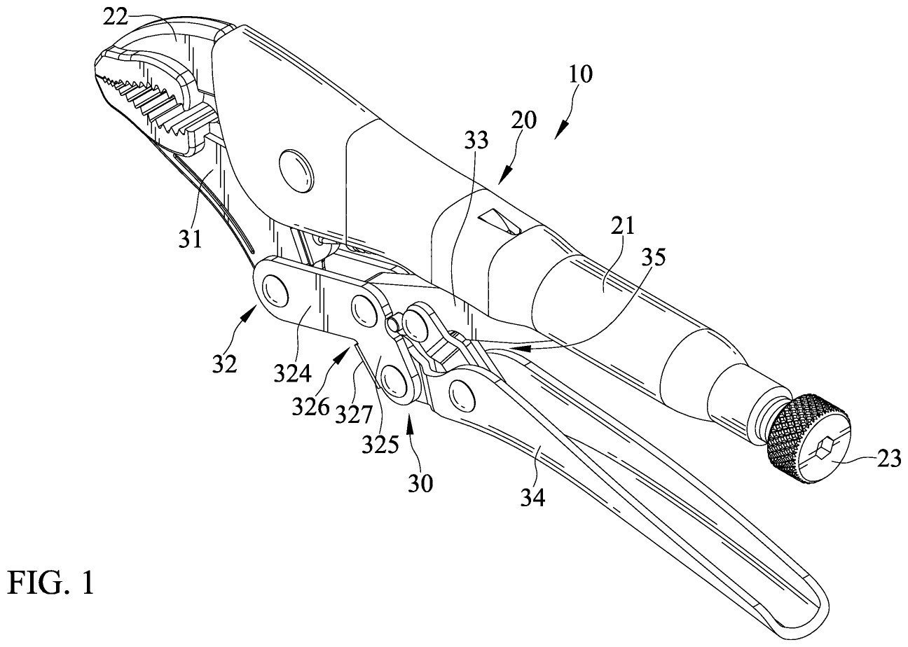

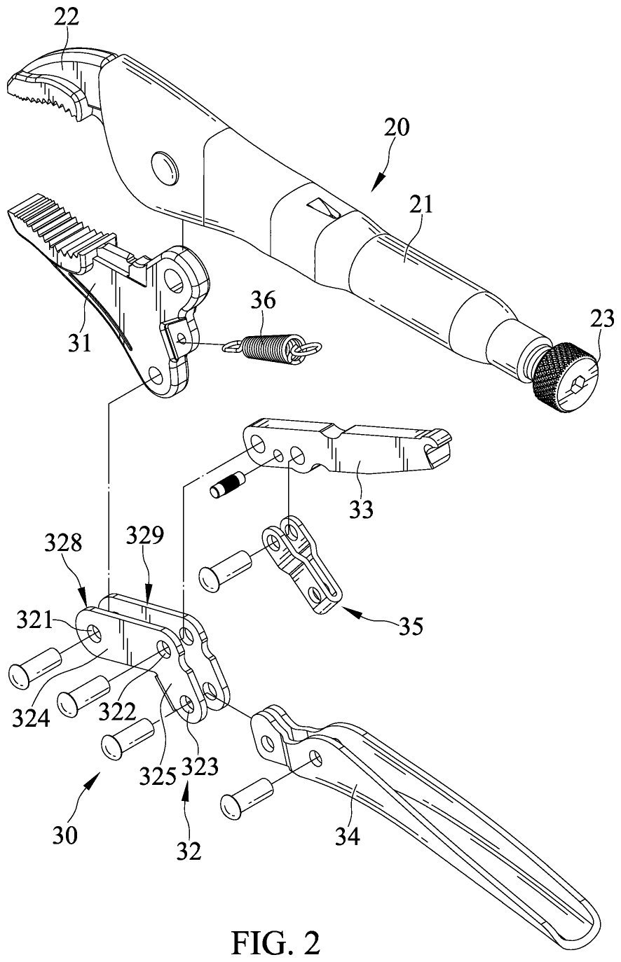

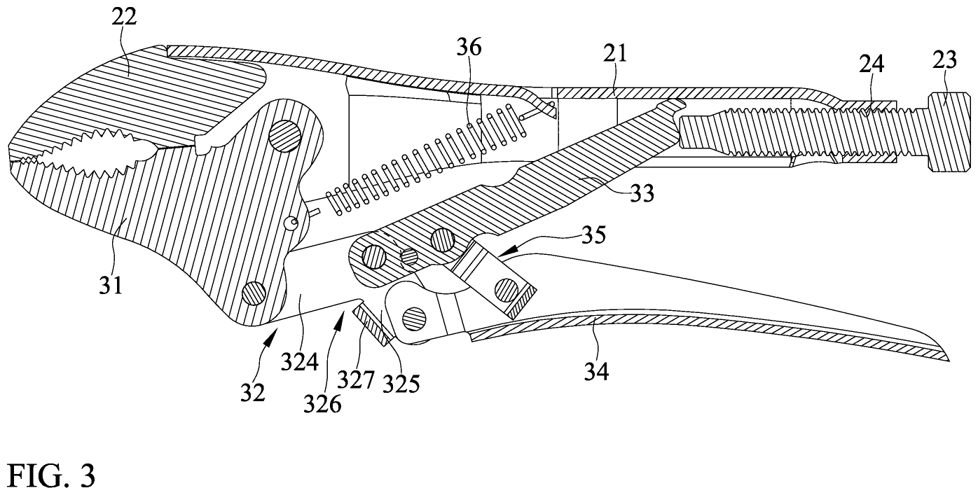

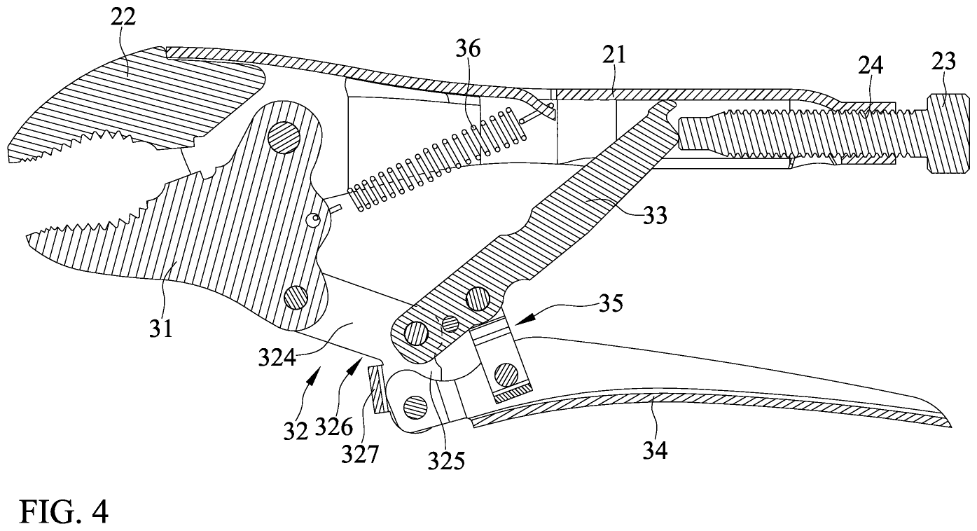

With reference to FIGS. 1-4, pliers 10 having a five-bar linkage of a first embodiment according to the present invention includes a first holder 20 and a second holder 30. The first holder 20 includes a first handle 21, a first jaw 22, and an adjusting member 23. The first jaw 22 is securely fixed to a first end of the first handle 21. The adjusting member 23 is connected to a second end of the first handle 21 remote from the first jaw 22. The second end of the first handle 21 remote from the first jaw 22 includes a screw hole 24. The adjusting member 23 is in threading connection with the screw hole 24. The adjusting member 23 is rotatable relative to the first handle 21 to move towards or away from the first jaw 22.

The second holder 30 includes a second jaw 31, a first connecting member 32, a toggle lever 33, a second handle 34, and a second connecting member 35. The second jaw 31 is pivotably mounted to the first end of the first handle 21 and faces the first jaw 22. The first connecting member 32 includes a first pivotal portion 321, a second pivotal portion 322, and a third pivotal portion 323. The first pivotal portion 321 is pivotably connected to the second jaw 31. A first end of the toggle lever 33 is pivotably connected to the second pivotal portion 322. A second end of the toggle lever 33 abuts against the adjusting member 23. The second end of the toggle lever 33 is remote from the first connecting member 32 and is jointly movable with the adjusting member 23 relative to the first handle 21. An end of the second handle 34 is pivotably connected to the third pivotal portion 323. A first end of the second connecting member 35 is pivotably connected between the first and second ends of the toggle lever 33. A second end of the second connecting member 35 is pivotably connected between two ends of the second handle 34.

A line passing through the first pivotal portion 321 and the second pivotal portion 322 is not coincident with another line passing through the second pivotal portion 322 and the third pivotal portion 323. The third pivotal portion 323 is located on a side of the second pivotal portion 322 opposite to the first handle 21. The first connecting member 32 includes a first connecting section 324 and a second connecting section 325. The first connecting section 324 connects the first pivotal portion 321 to the second pivotal portion 322. The second connecting section 325 connects the second pivotal portion 322 to the third pivotal portion 323. A recess 326 is formed in an angle between a side of the first connecting section 324 and a side of the second connecting section 325. The side of the first connecting section 324 and the side of the second connecting section 325 are opposite to the first handle 21. A stopper portion 327 is formed on a side of the second connecting section 325 adjacent to the recess 326.

The second holder 30 is movable relative to the first holder 20 between a holding position and a release position. When the second holder 30 is in the holding position, the second jaw 31 is adjacent to the first jaw 22, and the stopper portion 327 disengages from the second handle 34. When the second holder 30 is in the release position, the second jaw 31 is away from the first jaw 22, and the stopper portion 327 abuts against the second handle 34.

The first connecting member 32 includes a first plate 328 and a second plate 329. The first pivotal portion 321, the second pivotal portion 322, the third pivotal portion 323, the first connecting section 324, the second connecting section 325, and the recess 326 are disposed on the first plate 328. The second plate 329 has a structure identical to the first plate 328. An end of the stopper portion 327 is connected to the first plate 328. Another end of the stopper portion 327 is connected to the second plate 329. The first plate 328 and the second plate 329 are on two opposite sides of the second jaw 31. The toggle lever 33 is located between the first plate 328 and the second plate 329. The second handle 34 is located between the first plate 328 and the second plate 329.

The second holder 30 further includes an elastic element 36. An end of the elastic element 36 is connected to the second jaw 31 and is located between the first handle 21 and the first connecting member 32. Another end of the elastic element 36 is connected between the first and second ends of the first handle 21. The elastic element 36 provides a pulling force for both the second jaw 31 and the first handle 21. In this embodiment, the elastic element 36 is a tension spring.

By using the pliers 10 having the above structure, the spacing between the first handle 21 and the second handle 34 is not large when the first jaw 22 and the second jaw 31 are in the open position. This permits a user to operate the pliers 10 with single hand.

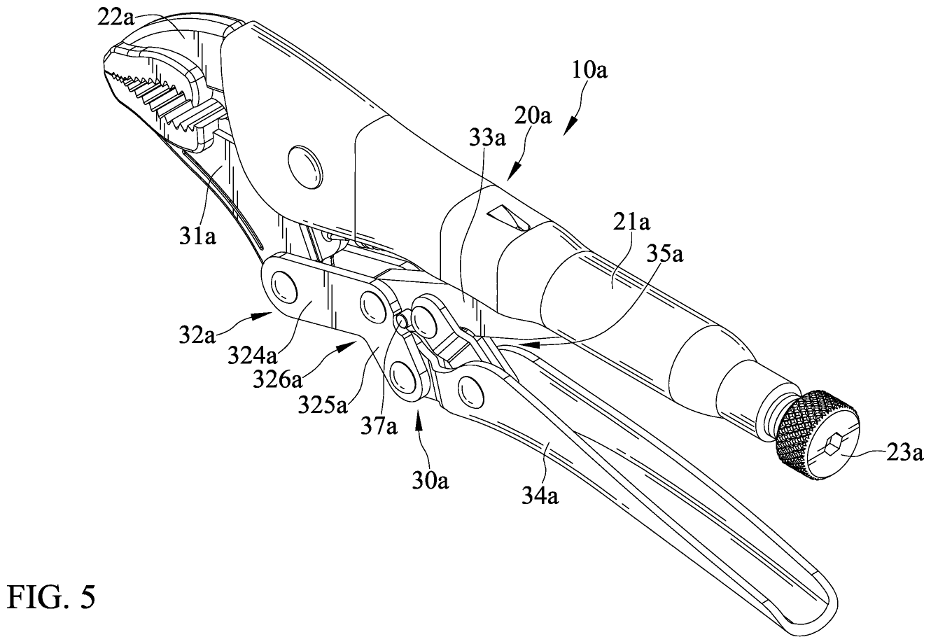

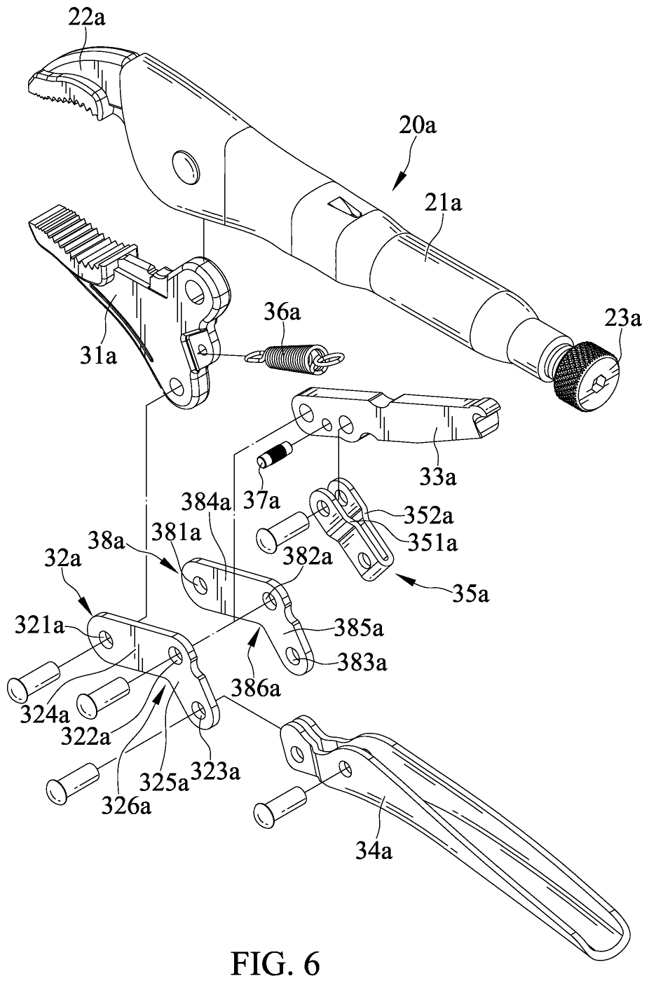

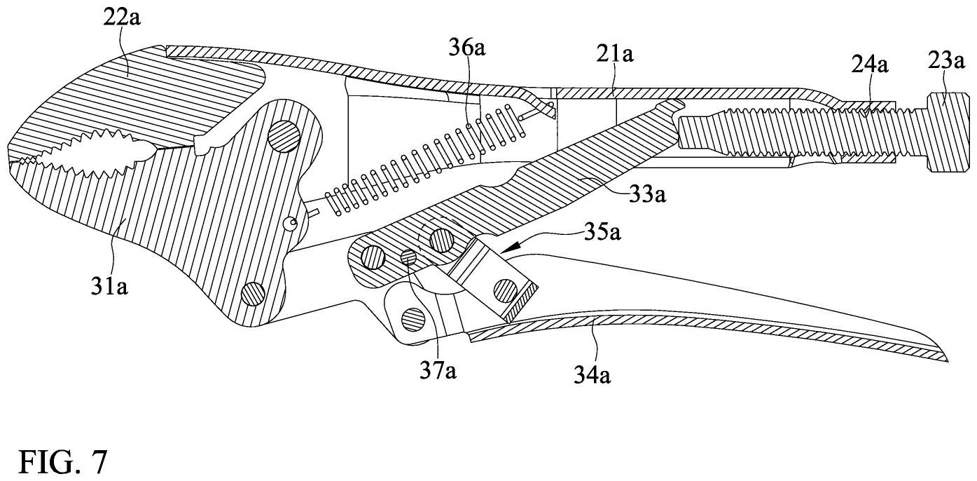

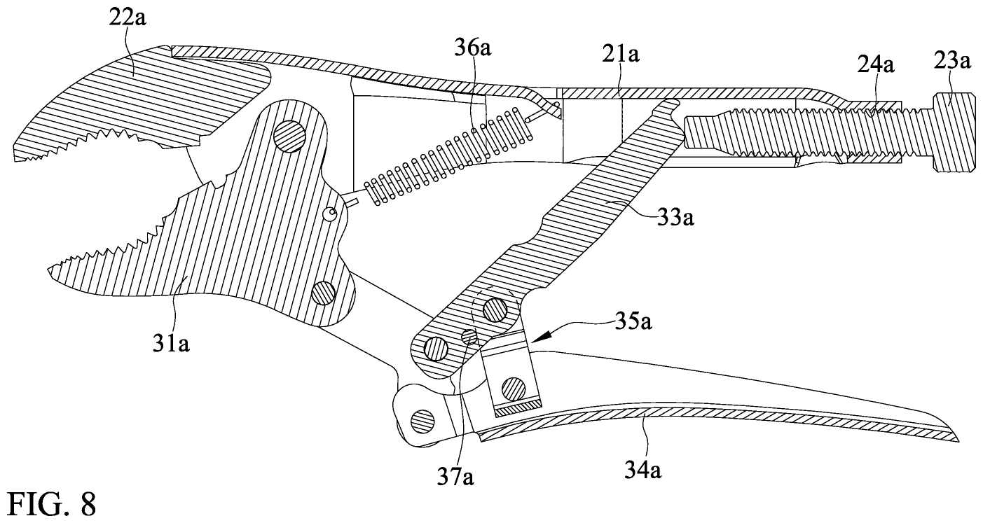

With reference to FIGS. 5-8, pliers 10a having a five-bar linkage of a second embodiment according to the present invention includes a first holder 20a and a second holder 30a. The first holder 20a includes a first handle 21a, a first jaw 22a, and an adjusting member 23a. The first jaw 22a is securely fixed to a first end of the first handle 21a. The adjusting member 23a is connected to a second end of the first handle 21a remote from the first jaw 22a. The second end of the first handle 21a remote from the first jaw 22a includes a screw hole 24a. The adjusting member 23a is in threading connection with the screw hole 24a. The adjusting member 23a is rotatable relative to the first handle 21a to move towards or away from the first jaw 22a.

The second holder 30a includes a second jaw 31a, a first connecting member 32a, a toggle lever 33a, a second handle 34a, a second connecting member 35a, and a stopper 37a. The second jaw 31a is pivotably mounted to the first end of the first handle 21a and faces the first jaw 22a. The first connecting member 32a includes a first pivotal portion 321a, a second pivotal portion 322a, and a third pivotal portion 323a. The first pivotal portion 321a is pivotably connected to the second jaw 31a. A first end of the toggle lever 33a is pivotably connected to the second pivotal portion 322a. A second end of the toggle lever 33a abuts against the adjusting member 23a. The second end of the toggle lever 33a is remote from the first connecting member 32a and is jointly movable with the adjusting member 23a relative to the first handle 21a. An end of the second handle 34a is pivotably connected to the third pivotal portion 323a. A first end of the second connecting member 35a is pivotably connected between the first and second ends of the toggle lever 33a. A second end of the second connecting member 35a is pivotably connected between two ends of the second handle 34a. The stopper 37a is connected to the toggle lever 33a and is located between the first connecting member 32a and the toggle lever 33a.

A line passing through the first pivotal portion 321a and the second pivotal portion 322a is not coincident with another line passing through the second pivotal portion 322a and the third pivotal portion 323a. The third pivotal portion 323a is located on a side of the second pivotal portion 322a opposite to the first handle 21a. The first connecting member 32a includes a first connecting section 324a and a second connecting section 325a. The first connecting section 324a connects the first pivotal portion 321a to the second pivotal portion 322a. The second connecting section 325a connects the second pivotal portion 322a to the third pivotal portion 323a. A first recess 326a is formed in an angle between a side of the first connecting section 324a and a side of the second connecting section 325a. The side of the first connecting section 324a and the side of the second connecting section 325a are opposite to the first handle 21a.

The second holder 30a is movable relative to the first holder 20a between a holding position and a release position. When the second holder 30a is in the holding position, the second jaw 31a is adjacent to the first jaw 22a, and the stopper 37a disengages from the second connecting member 35a. When the second holder 30a is in the release position, the second jaw 31a is away from the first jaw 22a, and the stopper 37a abuts against the second connecting member 35a.

The second connecting member 35a includes a first abutting portion 351a and a second abutting portion 352a. An end of each of the first abutting portion 351a and the second abutting portion 352a is pivotably connected to the toggle lever 33a. Another end of each of the first abutting portion 351a and the second abutting portion 352a is pivotably connected to the second handle 34a. The first abutting portion 351a and the second abutting portion 352a are located on two opposite sides of the toggle lever 33a. The stopper 37a extends through the toggle lever 33a and extends beyond the two opposite sides of the toggle lever 33a. When the second holder 30a is in the holding position, the stopper 37a disengages from the first abutting portion 351a and the second abutting portion 352a. When the second holder 30a is in the release position, the stopper 37a abuts against the first abutting portion 351a and the second abutting portion 352a.

The second holder 30a further includes an elastic element 36a. An end of the elastic element 36a is connected to the second jaw 31a and is located between the first handle 21a and the first connecting member 32a. Another end of the elastic element 36a is connected between the first and second ends of the first handle 21a. The elastic element 36a provides a pulling force for both the second jaw 31a and the first handle 21a. In this embodiment, the elastic element 36a is a tension spring.

The second holder 30a includes a third connecting member 38a. The third connecting member 38a includes a fourth pivotal portion 381a, a fifth pivotal portion 382a, and a sixth pivotal portion 383a. The fourth pivotal portion 381a is pivotably connected to the second jaw 31a. The first connecting member 32a and the third connecting member 38a are mounted on two opposite sides of the second jaw 31a, respectively. The first end of the toggle lever 33a is pivotably connected to the second pivotal portion 322a and the fifth pivotal portion 382a. The toggle lever 33a is located between the first connecting member 32a and the third connecting member 38a. An end of the second handle 34a is pivotably connected to the third pivotal portion 323a and the sixth pivotal portion 383a. The second handle 34a is located between the first connecting member 32a and the third connecting member 38a.

A line passing through the fourth pivotal portion 381a and the fifth pivotal portion 382a is not coincident with another line passing through the fifth pivotal portion 382a and the sixth pivotal portion 383a. The sixth pivotal portion 383a is located on a side of the fifth pivotal portion 382a remote from the first handle 21a. The third connecting member 38a includes a third connecting section 384a and a fourth connecting section 385a. The third connecting section 384a connects the fourth pivotal portion 381a to the fifth pivotal portion 382a. The fourth connecting section 385a connects the fifth pivotal portion 382a to the sixth pivotal portion 383a. A second recess 386a is formed in an angle between a side of the third connecting section 384a and a side of the fourth connecting section 385a. The side of the third connecting section 384a and the side of the fourth connecting section 385a are opposite to the first handle 21a.

By using the pliers 10a having the above structure, the spacing between the first handle 21a and the second handle 34a is not large when the first jaw 22a and the second jaw 31a are in the open position. This permits a user to operate the pliers 10a with single hand.

Although specific embodiments have been illustrated and described, numerous modifications and variations are still possible without departing from the scope of the invention. The scope of the invention is limited by the accompanying claims.

1. Pliers having a five-bar linkage, comprising:
a first holder including a first handle, a first jaw, and an adjusting member, wherein the first jaw is securely fixed to a first end of the first handle, and wherein the adjusting member is connected to a second end of the first handle remote from the first jaw; and
a second holder including a second jaw, a first connecting member, a toggle lever, a second handle, and a second connecting member, wherein the second jaw is pivotably mounted to the first end of the first handle and faces the first jaw, wherein the first connecting member includes a first pivotal portion, a second pivotal portion, and a third pivotal portion, wherein the first pivotal portion is pivotably connected to the second jaw, wherein a first end of the toggle lever is pivotably connected to the second pivotal portion, wherein a second end of the toggle lever abuts against the adjusting member, wherein one of two ends of the second handle is pivotably connected to the third pivotal portion, wherein a first end of the second connecting member is pivotably connected between the first and second ends of the toggle lever, wherein a second end of the second connecting member is pivotably connected between the two ends of the second handle,
wherein a line passing through the first pivotal portion and the second pivotal portion is not coincident with another line passing through the second pivotal portion and the third pivotal portion, wherein the third pivotal portion is located on a side of the second pivotal portion opposite to the first handle, wherein the first connecting member includes a first connecting section and a second connecting section, wherein the first connecting section connects the first pivotal portion to the second pivotal portion, wherein the second connecting section connects the second pivotal portion to the third pivotal portion, wherein a recess is formed in an angle between a side of the first connecting section and a side of the second connecting section, wherein the side of the first connecting section and the side of the second connecting section are opposite to the first handle, wherein a stopper portion is formed on a side of the second connecting section adjacent to the recess,
wherein the second holder is movable relative to the first holder between a holding position and a release position, wherein when the second holder is in the holding position, the second jaw is adjacent to the first jaw, and the stopper portion disengages from the second handle, wherein when the second holder is in the release position, the second jaw is away from the first jaw, and the stopper portion abuts against the second handle.

2. The pliers having the five-bar linkage as claimed in claim 1, wherein the first connecting member includes a first plate and the second plate, wherein the first pivotal portion, the second pivotal portion, the third pivotal portion, the first connecting section, the second connecting section, and the recess are formed on the first plate, wherein the second plate has a structure identical to the first plate, wherein an end of the stopper portion is connected to the first plate, wherein another end of the stopper portion is connected to the second plate, wherein the first plate and the second plate are on two opposite sides of the second jaw, wherein the toggle lever is located between the first plate and the second plate, and wherein the second handle is located between the first plate and the second plate.

3. The pliers having the five-bar linkage as claimed in claim 2, wherein the second end of the first handle opposite to the first jaw includes a screw hole, wherein the adjusting member is in threading connection with the screw hole, wherein the adjusting member is rotatable relative to the first handle to move towards or away from the first jaw, wherein the second end of the toggle lever is remote from the first connecting member and is jointly movable with the adjusting member relative to the first handle.

4. The pliers having the five-bar linkage as claimed in claim 3, wherein the second holder further includes an elastic element, wherein an end of the elastic element is connected to the second jaw and is located between the first handle and the first connecting member, wherein another end of the elastic element is connected between the first and second ends of the first handle, and wherein the elastic element provides a pulling force for both the second jaw and the first handle.

5. Pliers having a five-bar linkage, comprising:
a first holder including a first handle, a first jaw, and an adjusting member, wherein the first jaw is securely fixed to a first end of the first handle, wherein the adjusting member is connected to a second end of the first handle remote from the first jaw; and
a second holder including a second jaw, a first connecting member, a toggle lever, a second handle, a second connecting member, and a stopper, wherein the second jaw is pivotably mounted to the first end of the first handle and faces the first jaw, wherein the first connecting member includes a first pivotal portion, a second pivotal portion, and a third pivotal portion, wherein the first pivotal portion is pivotably connected to the second jaw, wherein a first end of the toggle lever is pivotably connected to the second pivotal portion, wherein a second end of the toggle lever abuts against the adjusting member, wherein one of two ends of the second handle is pivotably connected to the third pivotal portion, wherein a first end of the second connecting member is pivotably connected between the first and second ends of the toggle lever, wherein a second end of the second connecting member is pivotably connected between the two ends of the second handle, wherein the stopper is connected to the toggle lever and is located between the first connecting member and the toggle lever,
wherein a line passing through the first pivotal portion and the second pivotal portion is not coincident with another line passing through the second pivotal portion and the third pivotal portion, wherein the third pivotal portion is located on a side of the second pivotal portion opposite to the first handle, wherein the first connecting member includes a first connecting section and a second connecting section, wherein the first connecting section connects the first pivotal portion to the second pivotal portion, wherein the second connecting section connects the second pivotal portion to the third pivotal portion, wherein a first recess is formed in an angle between a side of the first connecting section and a side of the second connecting section, wherein the side of the first connecting section and the side of the second connecting section are opposite to the first handle,
wherein the second holder is movable relative to the first holder between a holding position and a release position, wherein when the second holder is in the holding position, the second jaw is adjacent to the first jaw, and the stopper disengages from the second connecting member, and wherein when the second holder is in the release position, the second jaw is away from the first jaw, and the stopper abuts against the second connecting member.

6. The pliers having the five-bar linkage as claimed in claim 5, wherein the second connecting member includes a first abutting portion and a second abutting portion, wherein an end of each of the first abutting portion and the second abutting portion is pivotably connected to the toggle lever, wherein another end of each of the first abutting portion and the second abutting portion is pivotably connected to the second handle, wherein the first abutting portion and the second abutting portion are located on two opposite sides of the toggle lever, wherein the stopper extends through the toggle lever and extends beyond the two opposite sides of the toggle lever, wherein when the second holder is in the holding position, the stopper disengages from the first abutting portion and the second abutting portion, and wherein when the second holder is in the release position, the stopper abuts against the first abutting portion and the second abutting portion.

7. The pliers having the five-bar linkage as claimed in claim 6, wherein the second holder includes a third connecting member, wherein the third connecting member includes a fourth pivotal portion, a fifth pivotal portion, and a sixth pivotal portion, wherein the fourth pivotal portion is pivotably connected to the second jaw, wherein the first connecting member and the third connecting member are mounted on two opposite sides of the second jaw, respectively, wherein the first end of the toggle lever is pivotably connected to the second pivotal portion and the fifth pivotal portion, wherein the toggle lever is located between the first connecting member and the third connecting member, wherein the one of the two ends of the second handle is pivotably connected to the third pivotal portion and the sixth pivotal portion, wherein the second handle is located between the first connecting member and the third connecting member,
wherein a line passing through the fourth pivotal portion and the fifth pivotal portion is not coincident with another line passing through the fifth pivotal portion and the sixth pivotal portion, wherein the sixth pivotal portion is located on a side of the fifth pivotal portion opposite to the first handle, wherein the third connecting member includes a third connecting section and a fourth connecting section, wherein the third connecting section connects the fourth pivotal portion to the fifth pivotal portion, wherein the fourth connecting section connects the fifth pivotal portion to the sixth pivotal portion, and wherein a second recess is formed in an angle between a side of the third connecting section and a side of the fourth connecting section, wherein the side of the third connecting section and the side of the fourth connecting section are opposite to the first handle.

8. The pliers having the five-bar linkage as claimed in claim 7, wherein the second end of the first handle remote from the first jaw includes a screw hole, wherein the adjusting member is in threading connection with the screw hole, wherein the adjusting member is rotatable relative to the first handle to move towards or away from the first jaw, and wherein the second end of the toggle lever is remote from the first connecting member and is jointly movable with the adjusting member relative to the first handle.

9. The pliers having the five-bar linkage as claimed in claim 8, wherein the second holder further includes an elastic element, wherein an end of the elastic element is connected to the second jaw and is located between the first handle and the first connecting member, wherein another end of the elastic element is connected between the first and second ends of the first handle, and wherein the elastic element provides a pulling force for both the second jaw and the first handle.
